(19) United States
(12) Patent Application Publication
(10) Pub. No.: US 2022/0294590 A1
(43) Pub. Date: Sep. 15, 2022

(54) METHOD, DEVICE AND COMPUTER STORAGE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/774,391

(22) PCT Filed: Nov. 5, 2019
(86) PCT No.: PCT/CN2019/115781

§ 371 Date: May 4, 2022

(51) Int. Cl. H04L 5/00

(52) U.S. Cl. CPC H04L 5/0051; H04L 5/0053; H04L 5/0094; H04L 5/0023

(57) ABSTRACT

Embodiments of the present disclosure relate to a method, device and computer readable mediun for communication. A method comprises in response to a physical resource block (PRB) being configured for communicating at least one Phase Tracking Reference Signal (PTRS) between a first device and a second device, determining, at the first device and from a plurality of resource elements (REs) comprised by the PRB, a first RE and a second RE for mapping at least one PTRS port; mapping the at least one PTRS port to at least one of the first and second REs; and communicating the at least one PTRS between the first device and the second device by using the at least one PTRS port. Embodiments of the present disclosure provide details on how to use two REs within one

PRB for PTRS communication to improve phase noise estimation performance, especially in case of scheme 2a/2b.

### TECHNICAL FIELD

Embodiments of the present disclosure generally relate to the field of communication, and more particularly, to a method, device and computer storage medium for communicating Phase Tracking Reference Signals (PTRSs).

### BACKGROUND

In the 3GPP meeting RAN#81, a new work item (WI) for NR Multiple Input Multiple Output (NR MIMO) was approved including several aspects. For example, it is to provide enhancements on multi-TRP/panel transmission including improved reliability and robustness with both ideal and non-ideal backhaul. In particular, it is to specify downlink control signaling enhancement(s) for efficient support of non-coherent joint transmission. It is to perform study and, if needed, specify enhancements on uplink control signaling and/or reference signal(s) for non-coherent joint transmission. Multi-Transmission and Reception Point (TRP)/multi-panel techniques for Ultra-Reliable Low latency Communications (URLLC) requirements are included in this WI.

To facilitate further down-selection for one or more schemes in RAN1#96bis, schemes for multi-TRP/multi-panel based URLLC, scheduled by single downlink control information (DCI) at least, are clarified. At least for some schemes (for example, URLLC scheme 2a/2b), it is possible to introduce a plurality of PTRS ports to improve phase noise estimation performance. However, details on how to map the plurality of PTRS ports have not been defined.

### SUMMARY

In general, example embodiments of the present disclosure provide a method, device and computer storage medium for communicating PTRSs.

In a first aspect, there is provided a method of communication. The method comprises: in response to a physical resource block (PRB) being configured for communicating at least one Phase Tracking Reference Signal (PTRS) between a first device and a second device, determining, at the first device and from a plurality of resource elements (REs) comprised by the PRB, a first RE and a second RE for mapping at least one PTRS port; mapping the at least one PTRS port to at least one of the first RE and the second RE; and communicating the at least one PTRS between the first device and the second device by using the at least one PTRS port.

In a second aspect, there is provided a device of communication. The device comprises a processor and a memory coupled to the processor. The memory stores instructions that when executed by the processor, cause the device to perform actions, the actions comprising: in response to a physical resource block (PRB) being configured for communicating at least one Phase Tracking Reference Signal (PTRS) between the device and a further device, determining, from a plurality of resource elements (REs) comprised by the PRB, a first RE and a second RE for mapping at least one PTRS port; mapping the at least one PTRS port to at least one of the first RE and the second RE; and communicating the at least one PTRS between the device and the further device by using the at least one PTRS port.

In a third aspect, there is provided a computer readable medium having instructions stored thereon. The instructions, when executed on at least one processor, cause the at least one processor to perform the method according to the first aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which implementations of the present disclosure can be implemented;

FIG. 2 illustrates an example signaling chart showing an example process for communicating PTRSs in accordance with some embodiments of the present disclosure;

FIG. 3 shows an example set of resources divided into two resource subsets associated with two TCI states, in accordance with some embodiments of the present disclosure;

FIGS. 4A-4B illustrate example schematic diagrams of mapping PTRS ports to REs within one PRB in accordance with some embodiments of the present disclosure;

FIGS. 5A-5B illustrate example schematic diagrams of mapping at least one PTRS port to REs within one PRB in accordance with some embodiments of the present disclosure;

FIGS. 6A-6D illustrate example schematic diagrams of mapping at least one PTRS port to REs within one PRB in accordance with some embodiments of the present disclosure;

FIG. 7 illustrates a flowchart of an example method in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure.

The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘some embodiments’ and ‘an embodiment’ are to be read as ‘at least some embodiments.’ The term ‘another embodiment’ is to be read as ‘at least one other embodiment.’ The terms ‘first,’ and the like may refer to different or same objects. Other definitions, explicit and implicit, may be included below.

In some examples, values, procedures, or apparatus are referred to as ‘best,’ ‘lowest,’ highest,“minimum,”maximum,' or the like. It will be appreciated that such descriptions are intended to indicate that a selection among many used functional alternatives can be made, and such selections need not be better, smaller, higher, or otherwise preferable to other selections.

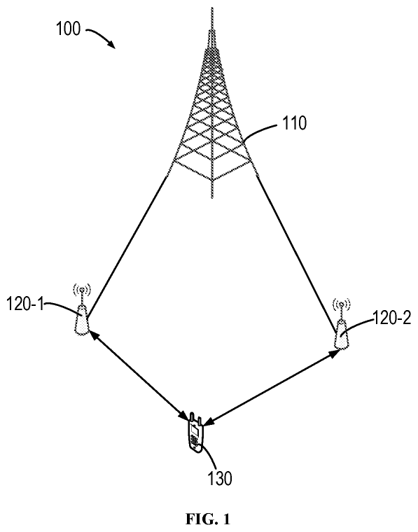

FIG. 1 illustrates an example communication network 100 in which embodiments of the present disclosure can be implemented. As shown in FIG. 1, the network 100 includes a network device 110, which is coupled with two TRPs/panels 120-1 and 120-2 (collectively referred to as TRPs 120 or individually referred to as TRP 120). The network 100 also includes a terminal device 130 served by the network device 110. It is to be understood that the number of network devices, terminal devices and TRPs as shown in FIG. 1 is only for the purpose of illustration without suggesting any limitations to the present disclosure. The network 100 may include any suitable number of devices adapted for implementing embodiments of the present disclosure.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. For the purpose of discussion, in the following, some embodiments will be described with reference to UE as an example of the terminal device 130.

As used herein, the term ‘network device’ or ‘base station’ (BS) refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like. The term “TRP” refers to an antenna array (with one or more antenna elements) available to the network device located at a specific geographical location. For example, a network device may be coupled with multiple TRPs in different geographical locations to achieve better coverage. It is to be understood that the TRP can also be referred to as a “panel”, which also refers to an antenna array (with one or more antenna elements) or a group of antennas.

In one embodiment, the terminal device 130 may be connected with a first network device and a second network device (not shown in FIG. 1). One of the first network device and the second network device may be in a master node and the other one may be in a secondary node. The first network device and the second network device may use different radio access technologies (RATs). In one embodiment, the first network device may be a first RAT device and the second network device may be a second RAT device. In one embodiment, the first RAT device may be an eNB and the second RAT device is a gNB. Information related to different RATs may be transmitted to the terminal device 130 from at least one of the first network device and the second network device. In one embodiment, first information may be transmitted to the terminal device 130 from the first network device and second information may be transmitted to the terminal device 130 from the second network device directly or via the first network device. In one embodiment, information related to configuration for the terminal device configured by the second network device may be transmitted from the second network device via the first network device. Information related to reconfiguration for the terminal device configured by the second network device may be transmitted to the terminal device from the second network device directly or via the first network device. The information may be transmitted via Radio Resource Control (RRC) signaling.

The communications in the network 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

As shown in FIG. 1, the network device 110 may communicate with the terminal device 130 via the TRPs 120-1 and 120-2. In the following text, the TRP 120-1 may be also referred to as the first TRP, while the TRP 120-2 may be also referred to as the second TRP. Each of the TRPs 120 may provide a plurality of beams for communication with the terminal device 130.

In some embodiments, the first and second TRPs 120 may be explicitly associated with different higher-layer configured identities. For example, a higher-layer configured identity can be associated with a pre-defined Control Resource Set (CORESET), a pre-defined reference signal (RS), or a pre-defined Transmission Configuration Indication (TCI) state, which is used to differentiate between transmissions between different TRPs 120 and the terminal device 130. When the terminal device 130 receives two DCIs from two CORESETs which are associated with different higher-layer configured identities, the two DCIs are indicated from different TRPs. Further, the first and second TRPs 120 may be implicitly identified by a dedicated configuration to the physical channels or signals. For example, a dedicated CORESET, a RS, and a TCI state, which are associated with a TRP, are used to identify a transmission from a different TRP to the terminal device 130. For example, when the terminal device 130 receives a DCI from a dedicated CORESET, the DCI is indicated from the associated TRP dedicated by the CORESET.

In the repeated transmission or reception via the two TRPs 120, the network device 110 may select a repetition scheme from among a number of available repetition schemes. The repetition scheme may specify a transmission manner for the network device 110 to use the two TRPs 120 cooperatively, for example, a multiplexing scheme between the two TRPs 120, the respective resource allocations for the two TRPs 120, or the like.

For example, to facilitate further down-selection for one or more schemes in RAN1#96bis, schemes for multi-TRP/multi-panel based URLLC, scheduled by single downlink control information (DCI) at least, are clarified as following.

Scheme 1 (SDM): n (n<=Nₛ) TCI states within the single slot, with overlapped time and frequency resource allocation.

Scheme 1a: Each transmission occasion is a layer or a set of layers of the same TB, with each layer or layer set is associated with one TCI and one set of DMRS port(s). Single codeword with one RV is used across all spatial layers or layer sets. From the UE perspective, different coded bits are mapped to different layers or layer sets with the same mapping rule as in Rel-15.

Scheme lb: Each transmission occasion is a layer or a set of layers of the same TB, with each layer or layer set is associated with one TCI and one set of DMRS port(s). Single codeword with one RV is used for each spatial layer or layer set. The RVs corresponding to each spatial layer or layer set can be the same or different. Codeword-to-layer mapping when total number of layers <=4 is for future study.

Scheme lc: One transmission occasion is one layer of the same TB with one DMRS port associated with multiple TCI state indices, or one layer of the same TB with multiple DMRS ports associated with multiple TCI state indices one by one.

In addition, it is indicated that applying different MCS/modulation orders for different layers or layer sets can be discussed.

Scheme 2 (FDM): n (n<=N_{f}) TCI states are within the single slot, with non-overlapped frequency resource allocation. Each non-overlapped frequency resource allocation is associated with one TCI state. Same single/multiple DMRS port(s) are associated with all non-overlapped frequency resource allocations.

Scheme 2a: Single codeword with one RV is used across full resource allocation. From UE perspective, the common RB mapping (codeword to layer mapping as in Rel-15) is applied across full resource allocation. In some embodiments, a terminal device may be configured or set with FDMschemeA by a high layer parameter. For example, the high layer parameter may be an RRC parameter. For example, the high layer parameter may be URLLCSchemeEnabler.

Scheme 2b: Single codeword with one RV is used for each non-overlapped frequency resource allocation. The RVs corresponding to each non-overlapped frequency resource allocation can be the same or different. In some embodiments, a terminal device may be configured or set with FDMschemeB by a high layer parameter. For example, the high layer parameter may be an RRC parameter. For example, the high layer parameter may be URLLCSchemeEnabler.

In addition, it is indicated that applying different MCS/modulation orders for different non-overlapped frequency resource allocations can be discussed. It is also indicated that details of frequency resource allocation mechanism for FDM 2a/2b with regarding to allocation granularity, time domain allocation can be discussed.

Scheme 3 (TDM): n (n<=Nₜ₁) TCI states within the single slot, with non-overlapped time resource allocation. Each transmission occasion of the TB has one TCI and one RV with the time granularity of mini-slot. All transmission occasion (s) within the slot use a common MCS with same single or multiple DMRS port(s). RV/TCI state can be same or different among transmission occasions. Channel estimation interpolation across mini-slots with the same TCI index is for future study. In some embodiments, a terminal device may be configured or set with TDMschemeA by a high layer parameter. For example, the high layer parameter may be an RRC parameter. For example, the high layer parameter may be URLLCSchemeEnabler.

Scheme 4 (TDM): n (n<=Nₜ₂) TCI states with K (n<=K) different slots. Each transmission occasion of the TB has one TCI and one RV. All transmission occasion (s) across K slots use a common MCS with same single or multiple DMRS port(s). RV/TCI state can be same or different among transmission occasions. Channel estimation interpolation across slots with the same TCI index is for future study.

In addition, before transmitting data (such as, via the TRP 120-1 and/or 120-2) to the terminal device 130, the network device 110 may transmit control information associated with the transmission of the data. For example, the control information can schedule a set of resources for the transmission of the data and indicate various transmission parameters related to the transmission of the data, such as, one or more TCI states, a Frequency Domain Resource Assignment (FDRA), a Time Domain Resource Assignment (TDRA) which may include a slot offset and a start/length indicator value, a Demodulation Reference Signal (DMRS) group, a Redundancy Version (RV), as defined in the 3GPP specifications. It is to be understood that the transmission parameters indicated in the control information 135 are not limited to the ones as listed above. Embodiments of the present disclosure may equally applicable to control information including any transmission parameters.

In some embodiments, the control information may include DCI as defined in the 3GPP specifications, which can indicate various transmission parameters dynamically, namely, on a relatively short time scale. In some other embodiments, the control information may include a Radio Resource Control (RRC) message or a Medium Access Control (MAC) Control Element (CE) message, which can indicate various transmission parameters semi-statically, that is, on a relatively long time scale.

In some multi-TRP/multi-panel communication schemes, single DCI can be used to schedule a number of Physical Downlink Shared Channel (PDSCH) or Physical Uplink Shared Channel (PUSCH) repetitions to achieve better performance. In current specifications, there may be a transmission control indication (TCI) field in DCI. For example, the TCI field may include 3 or 4 bits, and a value of the TCI field may be referred to as a “TCI code point”. A TCI code point may indicate one or more TCI states. A TCI state may indicate one Reference Signal (RS) set as well as parameters that configure quasi co-location (QCL) relationship between RSs within the RS set and DMRS ports for a PDSCH or a PUSCH. .

In addition to data communications, the network device 110 may transmit reference signals (RS) in broadcast, multi-cast, and/or unicast manners to the terminal device 130 in a downlink (such as, via the TRP 120-1 or 120-2). Similarly, the terminal devices 130 may transmit RSs to the network device 110 in an uplink (such as, via the TRP 120-1 or 120-2). As used herein, a “downlink (DL)” refers to a link from a network device to a terminal device, while an “uplink (UL)” refers to a link from the terminal device to the network device. Examples of the RS may include but are not limited to downlink or uplink Demodulation Reference Signal (DMRS), Channel State Information-Reference Signal (CSI-RS), Sounding Reference Signal (SRS), Phase Tracking Reference Signal (PTRS), fine time and frequency Tracking Reference Signal (TRS) and so on.

As used herein, a RS is a signal sequence (also referred to as “RS sequence”) that is known by both the network device 110 and the terminal device 130. For example, a RS sequence may be generated and transmitted by the network device 110 based on a certain rule and the terminal device 130 may deduce the RS sequence based on the same rule. In transmission of downlink and uplink RSs, the network device 110 may allocate corresponding resources (also referred to as “RS resources”) for the transmission and/or specify which RS sequence is to be transmitted.

In some scenarios, both the network device 110 and the terminal device 130 are equipped with multiple antenna ports (or antenna elements) and can transmit specified RS sequences with the antenna ports (antenna elements). A set of RS resources associated with a number of RS ports are also specified. A RS port may be referred to as a specific mapping of part or all of a RS sequence to one or more resource elements (REs) of a resource region allocated for RS transmission in time, frequency, and/or code domains. Such resource allocation information may be indicated to the terminal device 130 prior to the transmission of the RSs.

In NR, PTRS can be introduced to enable compensation for phase noise. Generally, the phase noise increases as the carrier frequency increases, so PTRS can be used to eliminate phase noise for a wireless network operating in high frequency bands. Currently, PTRS mapping patterns in time and frequency domains have been studied, but detailed patterns have not been designed completely. For example, it has been agreed that the density of PTRS in time domain (also referred to as “the time density” of PTRS) is associated with Modulation and Coding Scheme (MCS) being scheduled, while the density of PTRS in frequency domain (also referred to as “the frequency density” of PTRS) and the group pattern of PTRS ports (such as, the number of PTRS groups and the number of samples per PTRS group) are associated with a scheduled BW (such as, the number of scheduled RBs).

For an OFDM-based system, the time density of PTRS may be one of the following: zero (that is, PTRS is not present), every 4th symbol (that is, 1/4), every 2nd symbol (that is, 1/2), or every symbol (that is, 1). The time density of PTRS is associated with the scheduled MCS. For example, Table 5.1.6.3-1 of 3GPP TS 38.214 as below shows the association between the scheduled MCS and the time density of PTRS. In Table 5.1.6.3-1, ptrs-MCS 1 to ptrs-MCS4 each represent a MCS threshold which needs to be configured by the network device.

TABLE 5.1.6.3-1
Time density of PTRS as a function of scheduled MCS

| Scheduled MCS | Time density (L_{PT-RS}) |
|---|---|
| I_{MCS} < ptrs-MCS₁ | PTRS is not present |
| ptrs-MCS1 ≤ I_{MCS} < ptrs-MCS2 | 4 |
| ptrs-MCS2 ≤ I_{MCS} < ptrs-MCS3 | 2 |
| ptrs-MCS3 ≤ I_{MCS} < ptrs-MCS4 | 1 |

Similarly, the frequency density of PTRS may be one of the following: zero (that is, PTRS is not present), every RB (that is, 1), every 2nd RB (that is, 1/2), or every 4th RB (that is, 1/4). The frequency density of PTRS is associated with the scheduled bandwidth (that is, the number of scheduled RBs). For example, Table 5.1.6.3-2 of 3GPP TS 38.214 as below shows the association between the scheduled bandwidth (represented as NRB) and the frequency density of PTRS. In Table 5.1.6.3-2, NRBO and NRB1 each represent a bandwidth threshold which needs to be configured by the network device.

TABLE 5.1.6.3-2
Frequency density of PTRS as a function of scheduled PRBs

| Scheduled PRBs | Frequency density (K_{PT-RS}) |
|---|---|
| N_{RB} < N_{RB0} | PTRS is not present |
| N_{RB0} ≤ N_{RB} < N_{RB1} | 2 |
| N_{RB1} ≤ N_{RB} | 4 |

It has been agreed that single-DCI based M-TRP URLLC schemes 2a and 2b support the following design. Comb-like frequency resource allocation between/among

TRPs. For wideband Pre-coding Resource Block Group (PRG), first [N RB/2]RBs are assigned to TCI state 1 (also referred to as TCI state A) and the remaining [N RB/2]RBs are assigned to TCI state 2 (also referred to as TCI state B), where N RB represents the total number of allocated Resource Blocks. For PRG size=2 or 4, even PRGs within the allocated FDRA are assigned to TCI state 1 and odd PRGs within the allocated FDRA are assigned to TCI state 2.

It has also been agreed that if two TCI states are indicated by a TCI code point, at least for DMRS type 1 and type 2 for enhanced mobile broadband (eMBB), if indicated DMRS ports are from two CDM groups, the first TCI state is applied to the first indicated CDM group and the second TCI state is applied to the second indicated CDM group. It has also been agreed that for single-DCI based multi-TRP URLLC schemes 2a/2b/3/4, indicated DMRS ports are from one CDM group.

It has also been agreed that two PTRS ports for single-PDCCH based multi-TRP/multi-panel transmission are supported at least for eMBB and URLLC scheme la if two TCI states are indicated by the TCI field in one DCI, where the first/second PTRS port is associated with the lowest indexed DMRS port within DMRS ports corresponding to the first/second indicated TCI state, respectively.

In view of the above, at least for URLLC scheme 2a/2b, it is possible to introduce a plurality of PTRS ports (for example, two PTRS ports) to improve phase noise estimation performance. However, details on how to map the plurality of PTRS ports have not been defined.

In order to solve the above technical problems and potentially other technical problems in conventional solutions, embodiments of the present disclosure provide a solution for communicating PTRSs. In this solution, in response to a PRB being allocated for PTRS communication, two REs for mapping PTRS ports are determined from the PRB. Two PTRS ports may be mapped to the two REs respectively, or one of the two REs may be kept empty. As such, the network device and the terminal device can communicate PTRSs by using the PTRS ports. Embodiments of the present disclosure provide details on how to use two REs within one PRB for PTRS communication to improve phase noise estimation performance, especially in case of scheme 2a/2b.

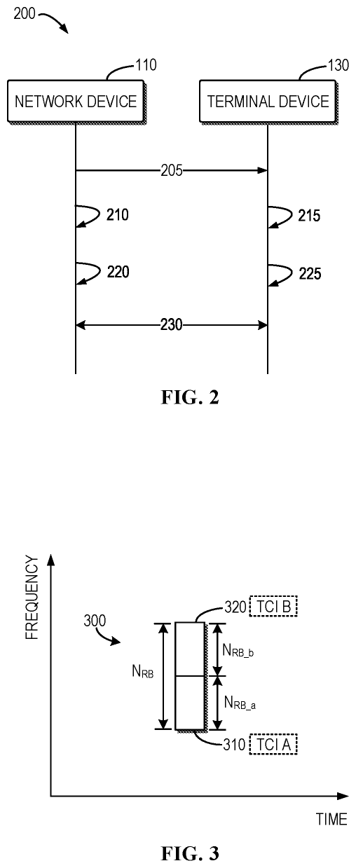

FIG. 2 illustrates an example signaling chart showing an example process 200 for communicating PTRSs in accordance with some embodiments of the present disclosure. As shown in FIG. 2, the process 200 may involve the network device 110 and the terminal device 130 as shown in FIG. 1. It is to be understood that the process 200 may include additional acts not shown and/or may omit some acts as shown, and the scope of the present disclosure is not limited in this regard.

As shown in FIG. 2, the network device 110 transmits 205 configuration information to the terminal device 130, for example, via the TRP 120-1 and/or 120-2. Accordingly, the terminal device 130 receives 205 the configuration information from the network device 110, for example, via the TRP 120-1 and/or 120-2. In some embodiments, the configuration information may include DCI as defined in the 3GPP specifications. In some other embodiments, the configuration information may include any existing or future signaling as defined in the 3GPP specifications or other standard specifications. The configuration information may indicate a set of resources and more than one TCI states to be used for communications between the terminal device 130 and the network device 110.

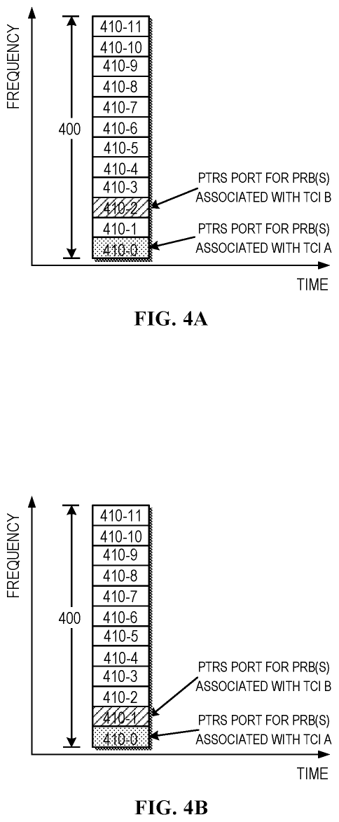

In some embodiments, the set of resources may include a plurality of physical resource blocks (PRBs) as defined in the 3GPP specifications. However, in some other embodiments, the set of resources can be in any other forms as defined in the 3GPP specifications or other standard specifications. In addition, in some embodiments, the TCI states may include up to eight TCI states as defined in the 3GPP specifications. However, in some other embodiments, the TCI states may include any existing or future transmission configuration indication states that have similar or same functions as that defined in the 3GPP specifications. In some embodiments, the set of resources indicated by the configuration information may be divided into different subsets associated with respective TCI states. An example will be described below with reference to FIG. 3.

FIG. 3 shows an example set of resources 300 divided in frequency domain into two resource subsets 310 and 320 associated with two TCI states in accordance with some embodiments of the present disclosure. In FIG. 3, the horizontal axis represents the time domain, and the vertical axis represents the frequency domain. For example, the configuration information transmitted from the network device 110 to the terminal device 130 may indicate the time and frequency positions of the set of resources 300, and may also indicate two of the eight TCI states as defined in 3GPP specifications, for example, TCI state A and TCI state B. The set of resources 300 as well as TCI state A and TCI state B are to be used in communications between the terminal device 130 and the network device 110. For example, TCI state A and TCI state B may be associated with different TRPs 120. As shown in FIG. 3, in some embodiments, the set of resources 300 may be divided into two subsets 310 and 320, each associated with one TCI state. For example, the subset 310 may be associated with TCI state A, while the subset 320 may be associated with TCI state B. It is to be understood that the number of TCI states, the wideband PRG configuration of the set of resources 300, and the specific partition manner of the set of resources 300 as shown in FIG. 3 are only for the purpose of illustration without suggesting any limitations. In other embodiments, there may be any suitable number of TCI states indicated in the control information 135, the set of resources 300 may have any suitable PRG configuration, and the set of resources 300 can be divided in any suitable manner into any number of subsets associated with respective TCI states.

Additionally, in some embodiments, the configuration information transmitted from the network device 110 to the terminal device 130 may also indicate which one of the set of resources is to be used for PTRS communication. For example, the configuration information transmitted from the network device 110 to the terminal device 130 may indicate which PRB is to be used for PTRS communication between the network device 110 and the terminal device 130.

Referring back to FIG. 2, in response to a PRB being configured for communicating at least one PTRS between the network device 110 and the terminal device 130, the network device 110 determines 210, from a plurality of REs comprised by the PRB, a first RE and a second RE for mapping at least one PTRS port. Likewise, in response to a PRB being configured for communicating at least one PTRS between the network device 110 and the terminal device 130, the terminal device 130 determines 215, from the plurality of REs comprised by the PRB, the first RE and the second RE for mapping at least one PTRS port in a similar way to the network device 110. For example, the PRB which includes PTRS may come from the subset 310 or 320 as shown in FIG. 3. That is, the PRB which includes PTRS may be associated with TCI state A or B.

In some embodiments, if PTRS is mapped to a PRB, there may be two REs in the PRB for mapping at least one PTRS port. For example, the first RE may be indexed with k_ref (also referred to as a “first index” in the following), while the second RE may be indexed with k ref2 (also referred to as a “second index” in the following).

In some embodiments, a PRB may include 12 REs, and the first index k ref may be a non-negative integer and 0 <k_ref <11. In some embodiments, the first index k_ref may be determined based on a given DMRS type according to current specifications. In some embodiments, for DMRS type 1, the first index k ref may be one of {0, 2, 6, 8}. Alternatively, in some embodiments, for DMRS type 1, the first index k ref may be one of {0, 2, 4, 6, 8, 10}. In some embodiments, for DMRS type 2, the first index k ref may be one of {0, 1, 6, 7}.

In some embodiments, a PRB may include 12 REs, and the second index k_ref2 may be a non-negative integer and 0 <k_ref2 <11. In some embodiments, the second index k_ref2 may be determined based on the first index k_ref and an offset k_offset, where 0 <k_offset <11. For example, k_ref2 =k_ref +k_offset, or k ref2 =(k_ref +k_offset) mod 12. In some embodiments, the available values of k_offset may depend on the DMRS type. In some embodiments, for DMRS type 1, the value of k_offset may be any of 2, 4, 6, 8 or 10, or the value of k_offset may be fixed to be 2 or 6. In some embodiments, for DMRS type 2, the value of k_offset may be any of 1, 6 or 7, or the value of k_offset may be fixed to be 1 or 6.

In some embodiments, the second index k_ref2 may be determined based on the first index k_ref and/or the DMRS type. In some embodiments, for DMRS type 1, the second index k_ref2 may be determined as following:

$$k\_ref2 = \{ \begin{matrix}2 , & if k\_ref = 0 \\ 0 , & if k\_ref = 2 \\ 8 , & if k\_ref = 6 \\ 6 , & if k\_ref = 8\end{matrix} or k\_ref2 = \{ \begin{matrix}2 , & if k\_ref = 0 \\ 6 , & if k\_ref = 2 \\ 8 , & if k\_ref = 6 \\ 0 , & if k\_ref = 8\end{matrix} \qquad ( 1 )$$

In some embodiments, for DMRS type 2, the second index k ref2 may be determined as following:

$$k\_ref2 = \{ \begin{matrix}1 , & if k\_ref = 0 \\ 0 , & if k\_ref = 1 \\ 7 , & if k\_ref = 6 \\ 6 , & if k\_ref = 7\end{matrix} or k\_ref2 = \{ \begin{matrix}1 , & if k\_ref = 0 \\ 6 , & if k\_ref = 1 \\ 7 , & if k\_ref = 6 \\ 0 , & if k\_ref = 7\end{matrix} \qquad ( 2 )$$

As such, the locations of two REs for mapping PTRS ports in one PRB can be determined.

Referring back to FIG. 2, in response to determining the first and second REs in the PRB, the network device 110 maps 220 the at least one PTRS port to at least one of the first and second REs. Likewise, in response to determining the first and second REs in the PRB, the terminal device 130 maps 225 the at least one PTRS port to at least one of the first and second REs in a similar way to the network device 110. Then, the network device 110 and the terminal device 130 communicate 230 PTRSs with each other by using the at least one PTRS port.

In some embodiments, two PTRS ports (for example, a first PTRS port and a second PTRS port) may be mapped to the first and second REs within one PRB. In some embodiments, for example, the first PTRS port may be mapped to the first RE, which is associated with TCI state A; and the second PTRS port may be mapped to the second RE, which is associated with TCI state B. For example, TCI states A and B may be associated with the TRPs 120-1 and 120-2 as shown in FIG. 1, respectively. That is, the first PTRS port may be used to communicate a PTRS via the first TRP 120-1, while the second PTRS port may be used to communicate a PTRS via the second TRP 120-2.

In some embodiments, the first PTRS port may be associated with the lowest indexed DMRS port, and mapped to the first RE indexed with k ref, where k_ref may be a non-negative integer and 0 <k_ref <11. In some embodiments, the second PTRS port may be mapped to the second RE indexed with k ref2, where k ref2 may be determined based on the first index k_ref and an offset k_offset. For example, k ref2 =k ref +k_offset, or k ref2 =(k_ref +k_offset) mod 12, where 0 <k_offset <11. In some embodiments, the second PTRS port may be mapped to the second RE indexed with k ref2, where k ref2 may be different from the first index k_ref and the value of k ref2 may be determined based on the value of k ref.

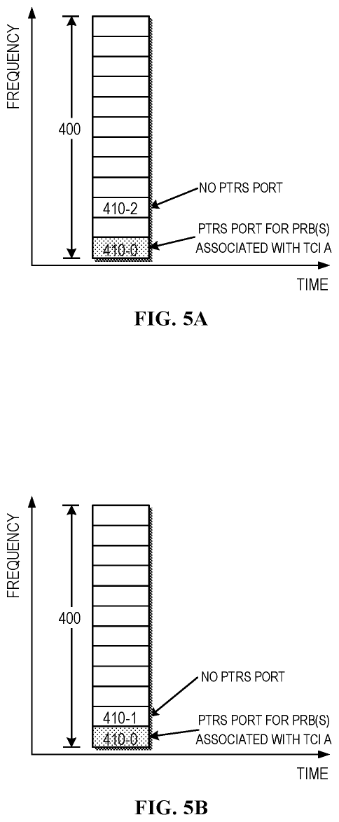

FIGS. 4A-4B illustrate example schematic diagrams of mapping two PTRS ports to two REs within one PRB in accordance with some embodiments of the present disclosure.

FIG. 4A shows an example for DMRS type 1. As shown in FIG. 4A, a PRB 400 configured for PTRS communication includes 12 REs 410-0, 410-1... 410-11. Two REs for mapping two PTRS ports are determined from the 12 REs, for example, the first RE 410-0 and the second RE 410-2. A first PTRS port may be associated with the lowest indexed DMRS port and mapped to the first RE 410-0. For example, the first PTRS port may be associated with TCI state A. A second PTRS port may be mapped to the second RE 410-2, which may be associated with TCI state B.

FIG. 4B shows an example for DMRS type 2. As shown in FIG. 4B, a PRB 400 configured for PTRS communication includes 12 REs 410-0, 410-1... 410-11. Two REs for mapping two PTRS ports are determined from the 12 REs, for example, the first RE 410-0 and the second RE 410-1. A first PTRS port may be associated with the lowest indexed DMRS port and mapped to the first RE 410-0. For example, the first PTRS port may be associated with TCI state A. A second PTRS port may be mapped to the second RE 410-1, which may be associated with TCI state B.

In view of the above, according to embodiments of the present disclosure, two PTRS ports can be mapped to same PRBs, if these PRBs include PTRSs. The two PTRS ports may be associated with different TCI states. As such, more PTRSs will be transmitted between the network device and the terminal device, thereby improving phase noise estimation/compensation performance.

Alternatively, in some embodiments, for the determined two REs within the PRB, one RE may be used for mapping a PTRS port, while the other RE may be kept empty (that is, no PTRS port is mapped to the other RE). As such, an Energy Per Resource Element (EPRE) ratio of PTRS to PDSCH will be 3dB higher, thereby improving the phase noise estimation/compensation performance.

According to some embodiments of the present disclosure, in some embodiments, if there are two REs within the PRB for PTRS mapping for a terminal device, and if the terminal device is configured with the higher layer parameter epre-Ratio, the ratio of PTRS

EPRE to PDSCH EPRE per layer per RE for PTRS port is given by Table 1 according to the parameter epre-Ratio. Otherwise, if the terminal device is not configured with the higher layer parameter epre-Ratio, the terminal device shall assume epre-Ratio is set to state ‘X’ in Table 1. In some embodiments, X is a non-negative integer. For example, X may be 0 or 2.

TABLE 1
PT-RS EPRE to PDSCH EPRE per layer per RE

| | The number of PDSCH layers | |
|---|---|---|
| epre-Ratio | 1 | 2 |
| X | 3 | 6 |
| X + 1 | 3 | 3 |

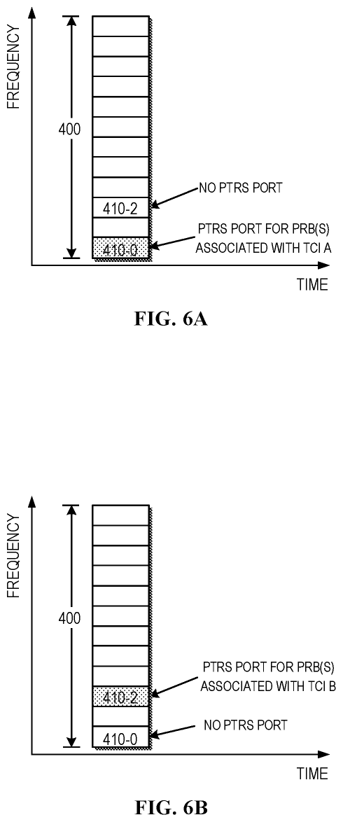

FIGS. 5A-5B illustrate example schematic diagrams of mapping at least one PTRS port to REs within one PRB in accordance with some embodiments of the present disclosure.

FIG. 5A shows an example for DMRS type 1. As shown in FIG. 5A, two REs 410-0 and 410-2 are determined for mapping at least one PTRS port in the PRB 400. The PTRS port is mapped to the first RE 410-0, while the second RE 410-2 is kept empty. For example, the PTRS port mapped to the first RE 410-0 may be associated with TCI state A.

FIG. 5B shows an example for DMRS type 2. As shown in FIG. 5B, two REs 410-0 and 410-1 are determined for mapping at least one PTRS port in the PRB 400. The PTRS port is mapped to the first RE 410-0, while the second RE 410-1 is kept empty. For example, the PTRS port mapped to the first RE 410-0 may be associated with TCI state A.

In some embodiments, if the PTRS is for PDSCH or PUSCH scheduled on PRBs associated with TCI state A, the PTRS port may be mapped to the first RE indexed with k_ref, while the second RE indexed with k ref2 may be kept empty. Alternatively, if the

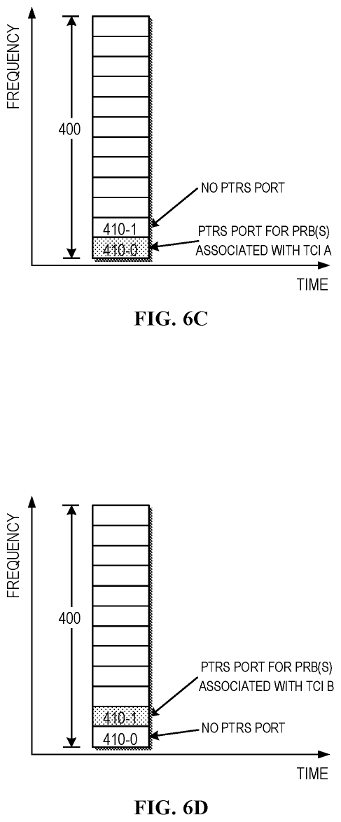

PTRS is for PDSCH or PUSCH scheduled on PRBs associated with TCI state B, the PTRS port may be mapped to the second RE indexed with k ref2, while the first RE indexed with k ref may be kept empty. FIGS. 6A-6D illustrate examples of such embodiments.

FIG. 6A shows an example for DMRS type 1. As shown in FIG. 6A, two REs 410-0 and 410-2 are determined for mapping at least one PTRS port in the PRB 400. For example, the PRB 400 is associated with TCI state A. In this case, the PTRS port is mapped to the first RE 410-0, while the second RE 410-2 is kept empty. For example, the PTRS port mapped to the first RE 410-0 may be associated with TCI state A.

FIG. 6B shows another example for DMRS type 1. As shown in FIG. 6B, two REs 410-0 and 410-2 are determined for mapping at least one PTRS port in the PRB 400. For example, the PRB 400 is associated with TCI state B. In this case, the PTRS port is mapped to the second RE 410-2, while the first RE 410-0 is kept empty. For example, the PTRS port mapped to the second RE 410-2 may be associated with TCI state B.

FIG. 6C shows an example for DMRS type 2. As shown in FIG. 6C, two REs 410-0 and 410-1 are determined for mapping at least one PTRS port in the PRB 400. For example, the PRB 400 is associated with TCI state A. In this case, the PTRS port is mapped to the first RE 410-0, while the second RE 410-1 is kept empty. For example, the PTRS port mapped to the first RE 410-0 may be associated with TCI state A.

FIG. 6D shows another example for DMRS type 2. As shown in FIG. 6D, two REs 410-0 and 410-1 are determined for mapping at least one PTRS port in the PRB 400. For example, the PRB 400 is associated with TCI state B. In this case, the PTRS port is mapped to the second RE 410-1, while the first RE 410-0 is kept empty. For example, the PTRS port mapped to the second RE 410-1 may be associated with TCI state B.

In some embodiments, whether one or both of the two REs within one PRB are to be used for mapping PTRS port(s) may be configured by configuration information transmitted from the network device 110 to the terminal device 130. For example, the configuration information may be transmitted via DCI or any higher layer signaling (such as, RRC signaling, or MAC layer signaling).

In some embodiments, for scheme 2a/2b/3/4, one or two DMRS ports may be from a same CDM group. In this case, the number of CDM groups without data may be assumed to be a fixed value. For example, the number of CDM group without data may be assumed to be 1 for DMRS type 1. For another example, the number of CDM group without data may be assumed to be 2 for DMRS type 1. For another example, the number of CDM group without data may be assumed to be 1 for DMRS type 2. For another example, the number of CDM group without data may be assumed to be 3 for DMRS type 2. For another example, the number of CDM group without data may be assumed to be 2 for DMRS type 2. According to some embodiments of the present disclosure, in some embodiments, for DMRS type 1 and/or DMRS type 2, if the number of CDM groups without data is greater than 1, the determined two REs within one PRB may be used for mapping two PTRS ports. However, if the number of CDM groups without data is 1, the PTRS port may be mapped to one of the determined two REs within one PRB, while the other RE may be kept empty. In some embodiments, for DMRS type 1 and/or DMRS type 2, if the number of CDM groups without data is greater than 1, there may be two PTRS ports within one PRB for PTRS mapping, and the determined two REs within the PRB may be used for mapping the two PTRS ports. Additionally, if the number of CDM groups without data is 1, there may be only one PTRS port within one PRB for PTRS mapping, and the PTRS port may be mapped to the RE with first index (for example, k ref) within the PRB. In some embodiments, for DMRS type 1 and/or DMRS type 2, if the number of CDM groups without data is greater than 1, there may be two REs within one PRB for PTRS mapping, and the PTRS port may be mapped to one of the determined two REs within the PRB. Additionally, if the number of CDM groups without data is 1, there may be only one PTRS port within one PRB for PTRS mapping, and the PTRS port may be mapped to the RE with first index (for example, k ref) within the PRB. That is, one PTRS port may be used across different repetitions.

In view of the above, embodiments of the present disclosure provide a solution for communicating PTRSs. In this solution, in response to a PRB being allocated for PTRS communication, two REs for mapping PTRS ports are determined from the PRB. Two PTRS ports may be mapped to the two REs respectively, or one of the two REs may be kept empty. As such, the network device and the terminal device can communicate PTRSs by using the PTRS ports. Embodiments of the present disclosure provide details on how to use two REs within one PRB for PTRS communication to improve phase noise estimation performance, especially in case of scheme 2a/2b.

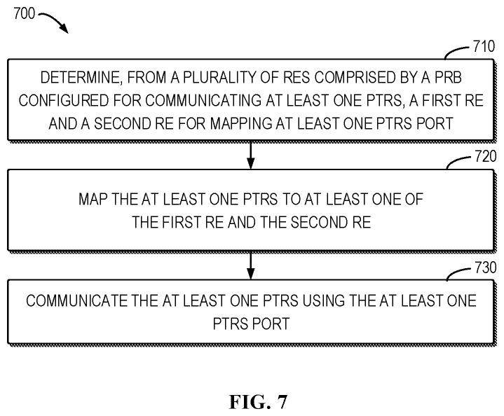

FIG. 7 illustrates a flowchart of an example method 700 in accordance with some embodiments of the present disclosure. The method 700 can be performed at a communication device (also referred to “first device” in the following). For example, the first device may be the network device 110 or the terminal device 130 as shown in FIG. 1. It is to be understood that the method 700 may include additional blocks not shown and/or may omit some blocks as shown, and the scope of the present disclosure is not limited in this regard.

At block 710, in response to a physical resource block PRB being configured for communicating at least one PTRS between a first device and a second device, the first device determines, from a plurality of REs comprised by the PRB, a first RE and a second RE for mapping at least one PTRS port.

In some embodiments, the first device may determine, based on a given DMRS type, a first index of the first RE within the plurality of REs. The first device may further determine, at least based on the first index, a second index of the second RE within the plurality of REs.

In some embodiments, determining the second index comprises: determining an offset of the second index relative to the first index; and determining the second index based on the first index and the offset.

In some embodiments, determining the second index comprises: determining the second index based on the first index and the given DMRS type.

At block 720, the first device maps the at least one PTRS port to at least one of the first RE and the second RE.

In some embodiments, the at least one PTRS port comprises a first PTRS port and a second PTRS port, and mapping the at least one PTRS port to at least one of the first RE and the second RE comprises: mapping the first PTRS port to the first RE; and mapping the second PTRS port to the second RE.

In some embodiments, mapping the at least one PTRS port to at least one of the first RE and the second RE comprises: mapping the at least one PTRS port to the first RE based on a given DMRS type, while mapping no PTRS port to the second RE.

In some embodiments, the PRB is associated with one of a first Transmission Configuration Indicator (TCI) state and a second TCI state to be used for communications between the first device and the second device, and mapping the at least one PTRS port to at least one of the first RE and the second RE comprises: in response to the PRB being associated with the first TCI state, mapping the at least one PTRS port to the first RE based on a given DMRS type, while mapping no PTRS port to the second RE; and in response to the PRB being associated with the second TCI state, mapping the at least one PTRS port to the second RE based on the given DMRS type, while mapping no PTRS port to the first RE.

At block 730, the first device communicate the at least one PTRS with the second device by using the at least one PTRS port.

In some embodiments, the first device comprises a network device, and the second device comprises a terminal device served by the network device.

In some embodiments, the first device comprises a terminal device, and the second device comprises a network device serving the terminal device.

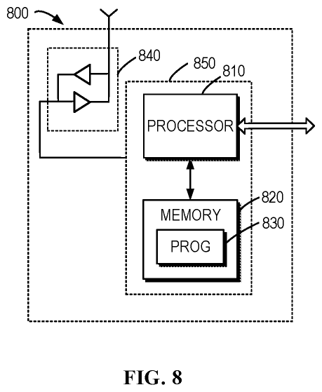

FIG. 8 is a simplified block diagram of a device 800 that is suitable for implementing embodiments of the present disclosure. The device 800 can be considered as a further example implementation of the network device 110 or the terminal device 130 as shown in FIG. 1. Accordingly, the device 800 can be implemented at or as at least a part of the network device 110 or the terminal device 130.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIG. 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
in response to a physical resource block (PRB) being configured for communicating at least one Phase Tracking Reference Signal (PTRS) between a first device and a second device, determining, at the first device and from a plurality of resource elements (REs) comprised by the PRB, a first RE and a second RE for mapping at least one PTRS port;
mapping the at least one PTRS port to at least one of the first RE and the second RE; and
communicating the at least one PTRS between the first device and the second device by using the at least one PTRS port.

2. The method of claim 1, wherein determining the first RE and the second RE comprises:
determining, based on a given Demodulation Reference Signal (DMRS) type, a first index of the first RE within the plurality of REs; and
determining, at least based on the first index, a second index of the second RE within the plurality of REs.

3. The method of claim 2, wherein determining the second index comprises:
determining an offset of the second index relative to the first index; and
determining the second index based on the first index and the offset.

4. The method of claim 2, wherein determining the second index comprises:
determining the second index based on the first index and the given DMRS type.

5. The method of claim 1, wherein the at least one PTRS port comprises a first PTRS port and a second PTRS port, and wherein mapping the at least one PTRS port to at least one of the first RE and the second RE comprises:
mapping the first PTRS port to the first RE; and
mapping the second PTRS port to the second RE.

6. The method of claim 1, wherein mapping the at least one PTRS port to at least one of the first RE and the second RE comprises:
mapping the at least one PTRS port to the first RE based on a given DMRS type, while mapping no PTRS port to the second RE.

7. The method of claim 1, wherein the PRB is associated with one of a first Transmission Configuration Indicator (TCI) state and a second TCI state to be used for communications between the first device and the second device, and wherein mapping the at least one PTRS port to at least one of the first RE and the second RE comprises:
in response to the PRB being associated with the first TCI state, mapping the at least one PTRS port to the first RE based on a given DMRS type, while mapping no PTRS port to the second RE; and
in response to the PRB being associated with the second TCI state, mapping the at least one PTRS port to the second RE based on the given DMRS type, while mapping no PTRS port to the first RE.

8. The method of claim 1, wherein the first device comprises a network device, and the second device comprises a terminal device served by the network device.

9. The method of claim 1, wherein the first device comprises a terminal device, and the second device comprises a network device serving the terminal device.

10. A device of communication, comprising:
a processor; and
a memory coupled to the processor and storing instructions thereon, the instructions, when executed by the processor, causing the device to perform actions, the actions comprising:
in response to a physical resource block (PRB) being configured for communicating at least one Phase Tracking Reference Signal (PTRS) between the device and a further device, determining, from a plurality of resource elements (REs) comprised by the PRB, a first RE and a second RE for mapping at least one PTRS port;
mapping the at least one PTRS port to at least one of the first RE and the second RE; and
communicating the at least one PTRS between the device and the further device by using the at least one PTRS port.

11. The device of claim 10, wherein determining the first RE and the second RE comprises:
determining, based on a given DMRS type, a first index of the first RE within the plurality of REs; and
determining, at least based on the first index, a second index of the second RE within the plurality of REs.

12. The device of claim 11, wherein determining the second index comprises:
determining an offset of the second index relative to the first index; and
determining the second index based on the first index and the offset.

13. The device of claim 11, wherein determining the second index comprises:
determining the second index based on the first index and the given DMRS type.

14. The device of claim 10, wherein the at least one PTRS port comprises a first PTRS port and a second PTRS port, and wherein mapping the at least one PTRS port to at least one of the first RE and the second RE comprises:
mapping the first PTRS port to the first RE; and
mapping the second PTRS port to the second RE.

15. The device of claim 10, wherein mapping the at least one PTRS port to at least one of the first RE and the second RE comprises:
mapping the at least one PTRS port to the first RE based on a given DMRS type, while mapping no PTRS port to the second RE.

16. The device of claim 10, wherein the PRB is associated with one of a first Transmission Configuration Indicator (TCI) state and a second TCI state to be used for communications between the device and the further device, and wherein mapping the at least one PTRS port to at least one of the first RE and the second RE comprises:
in response to the PRB being associated with the first TCI state, mapping the at least one PTRS port to the first RE based on a given DMRS type, while mapping no PTRS port to the second RE; and
in response to the PRB being associated with the second TCI state, mapping the at least one PTRS port to the second RE based on the given DMRS type, while mapping no PTRS port to the first RE.

17. The device of claim 10, wherein the device comprises a network device, and the further device comprises a terminal device served by the network device.

18. The device of claim 10, wherein the device comprises a terminal device, and the further device comprises a network device serving the terminal device.

19. A non-transitory computer readable medium having instructions stored thereon, the instructions, when executed on at least one processor, causing the at least one processor to perform actions, the actions comprising;
in response to a physical resource block (PRB) being configured for communicating at least one Phase Tracking Reference Signal (PTRS) between a first device and a second device, determining, at the first device and from a plurality of resource elements (REs) comprised by the PRB, a first RE and a second RE for mapping at least one PTRS port;
mapping the at least one PTRS port to at least one of the first RE and the second RE; and
communicating the at least one PTRS between the first device and the second device by using the at least one PTRS port.

20. The non-transitory computer readable medium of claim 19, wherein determining the first RE and the second RE comprises:
determining, based on a given Demodulation Reference Signal (DMRS) type, a first index of the first RE within the plurality of REs; and
determining, at least based on the first index, a second index of the second RE within the plurality of REs.
